(19) United States
(12) Patent Application Publication
(10) Pub. No.: US 2022/0392475 A1
(43) Pub. Date: Dec. 8, 2022

(54) Deep learning based noise reduction method using both bone-conduction sensor and microphone signals

(71) Applicant: Elevoc Technology Co., Ltd., Shenzhen, Guangdong (CN)

(72) Inventor: Youngjie Yan, Shenzhen, Guangdong (CN)

(21) Appl. No.: 17/042,973

(22) PCT Filed: Oct. 9, 2019
(86) PCT No.: PCT/CN2019/110080

§ 371 Date: Jul. 25, 2022

(51) Int. Cl. G10L 21/0232; G10L 25/30; H04R 3/00; G10L 25/18; H04R 1/08

(52) U.S. Cl. CPC G10L 21/0232; G10L 25/30; H04R 3/005; G10L 25/18; H04R 1/08; G10L 2021/02165

(57) ABSTRACT

A deep learning speech extraction and noise reduction method fusing signals of bone vibration sensor and microphone comprises steps of a bone vibration sensor and a microphone collecting audio signals to respectively obtain a bone vibration sensor audio signal and a microphone audio signal; inputting the bone vibration sensor audio signal into a high-pass filter module and performing high-pass filtering; inputting the bone vibration sensor audio signal subjected to high-pass filtering or a signal subjected to frequency band broadening, and the microphone audio signal into a DNN module; and the DNN model obtaining subjects by prediction and the subjects are subjected to fusing and noise reduction. By combining signals of bone vibration sensor and traditional microphone, the invention uses modeling of the DNN to realize high vocal reproduction and noise suppression. Signal obtained by performing frequency band broadening on a bone vibration sensor audio signal is used as output.

### BACKGROUND OF THE INVENTION

### 1. Field of the Invention

The invention relates to a method of noise reduction for an electronic voice capturing device and more particular to a deep learning based noise reduction method using both one bone-conduction sensor and one microphone signals.

### 2. Description of Related Art

Noise reduction is a technology for separating speech from background noise. The technology is widely employed in many electronic voice capturing devices. Conventionally, either a single microphone or microphone array for reducing noise is involved in the technology. However, the conventional technology has a number of drawbacks. In detail, the traditional single microphone technology assumes noise is stationary, so it is not highly adaptable, and has many limitations. The microphone array technology requires two or more microphones, which increases cost, requires a very complicated product design, and has limited applications in terms of product structure. Furthermore, the microphone array technology such as beamforming relies on spatial difference of target speech and interference noise. When target speech and noise source originate from the same direction, this method fails to separate them.

The conventional technology for noise reduction using at least one microphone has the following disadvantages: firstly, the greater of the number of the microphone the higher of the cost is. Secondly, there are many limitations for microphones in terms of structure. Thirdly, noise reduction is direction oriented rather than noise approaching the person of target. Fourthly, for a single microphone, noise reduction is made possible based on stable noise. However, this is limited.

The invention is directed to a deep learning based noise reduction method using both bone-conduction sensor and microphone signals. It can extract clear speech in a noisy environment. It is applicable to headphones, mobile phones or the like that attach to the ears or other body parts. In comparison with the conventional art of involving at least one microphone, it uses bone vibration sensors to make stable communication even in a noisy environment such as subway or windy field. In comparison with the conventional art of involving a single microphone, it can does not assume noise to be stable and this is contrast to the conventional technology involving a single microphone which assumes noise to be stable. It can retract clear speech and has significant noise reduction using DNN. Thus, the problem of being difficult of extracting clear speech in a noisy environment is solved. In comparison with the conventional art of involving more than one microphone for noise reduction, only one microphone is used by the invention.

Regarding microphone, the bone vibration sensor signals are sampled in low frequency range and thus interference from the air is very small. In comparison with the conventional art of involving microphone and bone vibration sensor which uses bone-conducted signals are target for activating speech. The invention uses bone-conducted signals as low frequency signals as input. After an alternative step of high frequency restructuring, both the bone-conducted signals and the microphone signals are together sent to the DNN to fuse for reducing noise. Quality low frequency signals are obtained using the bone vibration sensor. Thereafter, DNN prediction is more precise and noise is reduced.

The Chinese Patent Application Number 201710594168.3 is entitled “A general real time noise reduction method for monaural sound”. In comparison with it, the invention uses bone-conducted signals as low frequency signals as input. Both the bone-conducted signals and the microphone signals are together sent to the DNN to fuse for reducing noise. Quality low frequency signals are obtained using the bone vibration sensor. Thereafter, noise is reduced.

The Chinese Patent Application Number 201811199154.2, entitled “system for identifying voice of a user to control an electronic device through human vibration”, comprises a vibration sensor for sensing body vibration of a user, a processor circuit coupled to the vibration sensor for activating a voice pickup device to begin voice pickup when the output signal of vibration sensor detects voice of the user. In comparison with it, the invention uses bone-conducted signals as low frequency signals as input. Both the bone-conducted signals and the microphone signals are together sent to the DNN to fuse for reducing noise. Quality low frequency signals are obtained using the bone vibration sensor. Thereafter, noise is reduced.

### SUMMARY OF THE INVENTION

The invention proposes a deep learning based noise reduction method by using both bone-conduction sensor signal and a microphone signal. It helps to solve current technical problems relating to stringent product structure design of multiple microphones, high cost, and many limitations related to single microphone noise reduction technique. In comparison with the conventional art of involving microphone and bone vibration sensor which uses bone-conducted signals are target for activating speech. The invention uses bone-conducted signals as low frequency signals as input. After an alternative step of high frequency restructuring, both the bone-conducted signals and the microphone signals are together sent to the DNN to fuse for reducing noise. Quality low frequency signals are obtained using the bone vibration sensor. Thereafter, DNN prediction is more precise and noise is reduced.

The invention further proposes a deep learning based noise reduction method by using both bone-conduction sensor signal and a microphone signal for solving conventional technical problems relating to stringent product structure design of multiple microphones, high cost, and many limitations related to single microphone noise reduction technique. The invention can extract clear speech in a noisy environment. It is applicable to headphones, mobile phones or the like that attach to the ears or other body parts.

To solve above technical difficulties, this invention proposes a deep learning speech extraction and noise reduction method fusing signals of bone vibration sensor and microphone, comprising the steps of S1 a bone vibration sensor and a microphone collecting audio signals to respectively obtain a bone vibration sensor audio signal and a microphone audio signal; S2 inputting the bone vibration sensor audio signal into a high-pass filter module, and performing high-pass filtering; S3 inputting the bone vibration sensor audio signal subjected to high-pass filtering or a signal subjected to frequency band broadening and the microphone audio signal into a deep neural network module; S4 the deep neural network module obtaining, by means of prediction, speech have been subjected fusing and noise reduction.

In the deep learning speech extraction and noise reduction method fusing signals of bone vibration sensor and microphone of the invention wherein the high-pass filter modifies a direct current offset of the bone sensor signal and filters out low frequency noise signals.

In the deep learning speech extraction and noise reduction method fusing signals of bone vibration sensor and microphone of the invention wherein the filtered bone-conducted signal is further subjected to a high frequency reconstruction module to extend the frequency of the filtered bone-conducted signals to more than 2 kHz so that a bandwidth of the filtered bone-conducted signals is increased and the filtered bone-conducted signals are further sent to the DNN module.

In the deep learning speech extraction and noise reduction method fusing signals of bone vibration sensor and microphone of the invention wherein after subjecting the bone-conducted signals to the high frequency restructuring, the bone-conducted signals can be outputted.

In the deep learning speech extraction and noise reduction method fusing signals of bone vibration sensor and microphone of the invention wherein the DNN module comprises a fusing module for fusing the speech signals from the microphone and the bone-conducted signals from the bone-conduction sensor into noise reduction.

In the deep learning speech extraction and noise reduction method fusing signals of bone vibration sensor and microphone of the invention wherein one of a plurality of implementations of the DNN module is a convolutional neural network (CNN) which is capable of obtaining a speech magnitude spectrum (SMS) by making predictions.

In the deep learning speech extraction and noise reduction method fusing signals of bone vibration sensor and microphone of the invention whereinthe DNN module comprises a plurality of the CNNs, a plurality of long short-term memories (LSTMs), and a plurality of deconvolutional neural networks.

In the deep learning speech extraction and noise reduction method fusing signals of bone vibration sensor and microphone of the invention wherein the clean speech is subjected to Short-time Fourier transform (STFT) to obtain a SMS as a target magnitude spectrum (TMS).

In the deep learning speech extraction and noise reduction method fusing signals of bone vibration sensor and microphone of the invention wherein input signals of the DNN module are generated by stacking the SMS of the bone sensor based signal and the SMS of the microphone based voice signal; wherein both the bone sensor based signal and the microphone based voice signal are subjected to STFT to obtain two magnitude spectrums; and wherein the magnitude spectrums are configured to stack.

In the deep learning speech extraction and noise reduction method fusing signals of bone vibration sensor and microphone of the invention wherein the stacked magnitude spectrums are processed by the DNN module to generate an estimated magnitude spectrum (EMS) to be outputted.

In the deep learning speech extraction and noise reduction method fusing signals of bone vibration sensor and microphone of the invention wherein each of the TMS and the EMS are subjected to mean squared error (MSE).

The deep learning speech extraction and noise reduction method fusing signals of bone vibration sensor and microphone of the invention has the following advantageous effects in comparison with the prior art:
The bone sensor is capable of collecting low frequency voice and is not interfered by air conducted acoustic noise. It effectively reduces noise in a very low SNR by transmitting both the bone-conduction sensor signal and the microphone signal to the DNN module. In comparison with the conventional method, the invention can reproduce high-quality sound, has a strong capability of cancelling noise, and effectively extracts target speech from noisy background by employing the strong modeling capability of the DNN. The invention is applicable to conversation earphone or a cellular phone contacted an ear or any of other body parts. The invention takes the bone sensor signals as input by taking advantage of the bone sensor signals not being affected by acoustic noise interference. The invention can generate low frequency signals of high quality by taking advantage of the bone sensor. The invention can greatly increase prediction accuracy of the DNN, thereby obtaining a clean speech. After an alternative step of high frequency restructuring, both the bone-conducted signals and the microphone signals are together sent to the DNN to fuse for reducing noise. Quality low frequency signals are obtained using the bone vibration sensor. Thereafter, DNN prediction is more precise and noise is reduced. The invention reproduced high-quality sound, has a strong capability of suppressing noise, and effectively collect speech from noisy background by employing the strong modeling capability of the DNN. A clean speech with noise being substantially suppressed is reproduced.

### BRIEF DESCRIPTION OF THE DRAWINGS

The above and other objects, features and advantages of the invention will become apparent from the following detailed description taken with the accompanying drawings.

FIG. 1 is a flowchart of a deep learning based noise reduction method by processing signals collected by both a bone-conduction sensor and a microphone according to a preferred embodiment of the invention;

FIG. 2 is a block diagram of details of the high frequency restructuring step;

FIG. 3 is a block diagram of deep neural network (DNN) incorporated into the invention;

FIG. 4 is a spectrogram of signal collected by the bone-conduction sensor of the invention;

FIG. 5 is a spectrogram of signal collected by the microphone of the invention;

FIG. 6 is a spectrogram of speech signal processed by the invention; and

FIG. 7 is a table of comparing the noise reduction method of the invention with the deep learning based noise reduction method without incorporating a bone sensor for monaural sound in terms of eight different noisy environments and showing advantageous noise reduction results of the invention.

### DETAILED DESCRIPTION OF THE INVENTION

The invention will be described more fully herein after with reference to the accompanying figures, in which examples of the present principles are shown. The invention may, however, be embodied in many alternate forms and should not be construed as limited to the examples set forth herein.

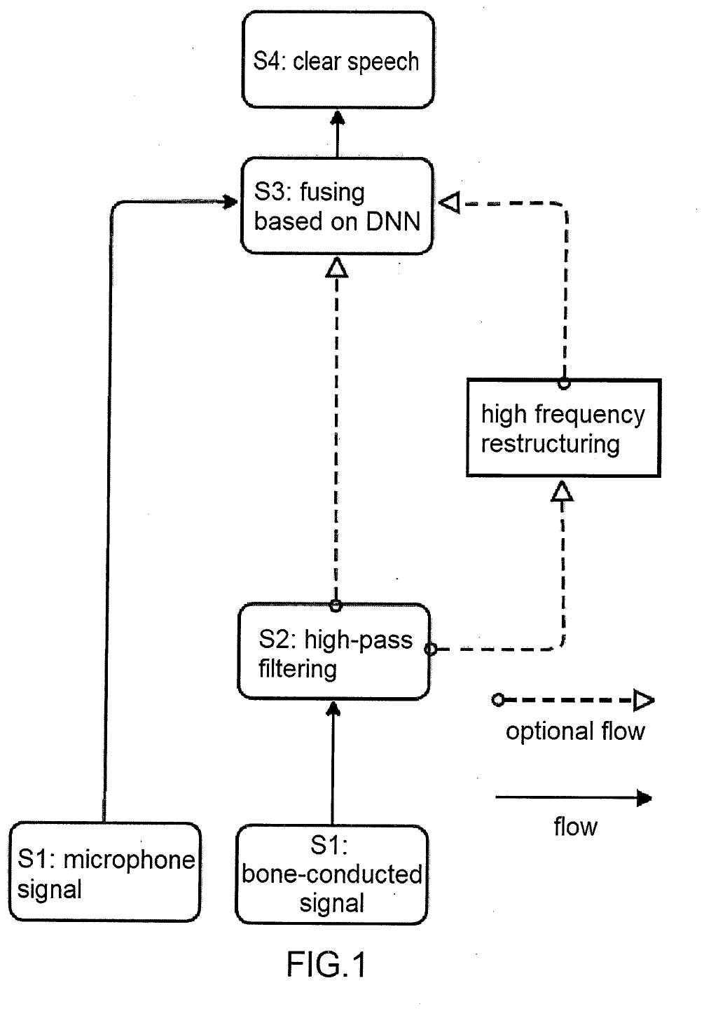

Referring to FIG. 1, a flowchart of a deep learning based noise reduction method of processing signals from both a bone-conduction sensor and a microphone according to a preferred embodiment of the invention is illustrated. The method comprises the steps of:
(S1) collecting speech signals from a microphone and collecting bone-conducted signals from a bone-conduction sensor;
(S2) transmitting the bone-conducted signals to a high-pass filter to filter out low frequency noise;
(S3) transmitting both the filtered bone-conducted signals and the speech signals to a deep neural network (DNN) module;
(S4) activating the DNN module to process both the filtered bone-conducted signals and the speech signals and making predictions, thereby obtaining a clean speech. The invention has the following advantageous effects in comparison with the prior art: A bone-conduction sensor is utilized. The bone-conduction sensor is not interfered by acoustic noise propagated through air. Through combining both the filtered bone-conducted signal and the microphone signal to the DNN module, and activating the DNN module to analyze and process the combination signals, satisfactory performance of noise reduction can be achieved even in super low signal-to-noise ratio (SNR) conditions.

The most advanced noise reduction method so far is based on deep learning network (DNN) which uses a large amount of data for training. While the method is capable of separating the speech of a specific person from background noise without being trained, this model is speaker independent. To improve the performance of noise reduction for an unspecific person, the most effective method is to add the voices of many persons to training set. However, in this case, the DNN cannot suppress the interfering voice effectively. Even worse, the DNN may erroneously take interfering voice as target speaker voice and suppress the true target speaker voice.

The Chinese Patent Application Number 201710594168.3, entitled “A general real time noise reduction method for monaural sound”, the method comprises the steps of receiving noisy speech in an electronic form, which includes target speaker voice and interfered non-speech noise; extracting the magnitude spectrum of Short-time Fourier transform (STFT) as acoustic features in a frame by frame manner; using a deep recurrent neural network (RNN) having a long short-term memory (LSTM) to generate ideal ratio masks in a frame by frame manner; multiplying the estimated ratio mask and the magnitude spectrum of the noisy speech; combining the magnitude spectrum and the original phases of the noisy speech to form a clean voice waveform. This patent disclosed a supervised learning method for noise reduction. It further disclosed using a deep RNN with LSTM to generate ideal ratio mask. The RNN uses a large amount of noisy speeches for training, including various noises and microphone impulse responses. As a result, a general noise reduction method is realized which is independent from speakers, background noises and transmission channels. The monaural noise reduction method involves only processing signals recorded by a single microphone. Compared with microphone array noise reduction method which requires multiple microphones, the monaural noise reduction method has wider applications and low cost. In comparison with it, the invention uses bone-conducted signals as low frequency signals as input. Both the bone-conducted signals and the microphone signals are together sent to the DNN to fuse for reducing noise. Quality low frequency signals are obtained using the bone vibration sensor. Thereafter, noise is reduced.

Preferably, the bone-conduction sensor is capable of collecting low frequency bone vibration and is not interfered by air conduced acoustic noise. It is possible to effectively reduce noise in a very low SNR in full frequency band by combining both the filtered bone-conducted sensor signal and the microphone signal with the DNN module, and activating the DNN module to analyze and process the combination signals. The bone sensor of the embodiment is a known technique.

Speech signals have a strong correlation in time which is critical to voice separation. For improving the performance of voice separation in terms of context, the DNN is used to concatenate the previous frames, the current frame and the subsequent frames as a vector having an increased dimension and the vector is taken as a characteristic of input. The method of the invention is performed by running a program on a computer. Acoustic features are extracted from noisy speech. An ideal time frequency ratio mask is estimated. Together they are combined again to form a voice waveform. The method involves at least one module which can be executed by any system or hardware having computer executable instructions.

Preferably, the high-pass filter modifies the direct current offset of the bone sensor signal and filters out low frequency noise signal.

More preferably, the high-pass filter is a digital filter.

Preferably, the bone-conducted signals is transmitted to a high-pass filter to filter out low frequency noise, a high frequency reconstruction module is designed to extend the frequency of the filtered bone-conducted signals to more than 2 kHz (i.e., high frequency restructuring for increasing a bandwidth of the filtered bone-conducted signals) and both the filtered bone-conducted signals having an extended frequency range and the speech signals are transmitted to a deep neural network (DNN) module.

Preferably, the filtered bone-conducted signal further subjected to a high frequency reconstruction module to extend the frequency of the filtered bone-conducted signals is optional.

More preferably, many methods are capable of restructuring high frequency. The DNN is the most effective method so far. In the embodiment, only one kind of DNN is described as an exemplary example.

The above steps of transmitting bone-conducted signals to a high-pass filter to filter out low frequency noise, designing a high frequency reconstruction module to extend the frequency of the filtered bone-conducted signals to more than 2 kHz (i.e., high frequency restructuring for increasing a bandwidth of the filtered bone-conducted signals) and transmitting both the filtered bone-conducted signals having an extended frequency range and the speech signals to a deep neural network (DNN) module are optional. The above steps are performed after step (S1) of collecting speech signals from a microphone and collecting bone-conducted signals from a bone-conduction sensor, and step (S2) of transmitting the bone-conducted signals to a high-pass filter to filter out low frequency noise. Thereafter, the DNN module is activated to process both the filtered bone-conducted signals having an extended frequency range and the speech signals and making predictions, thereby obtaining a clean speech.

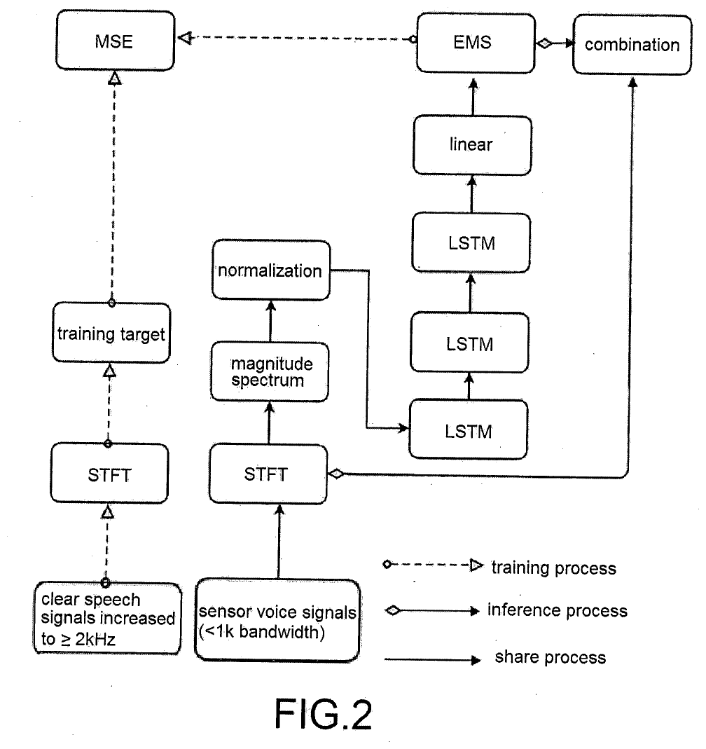

Referring to FIG. 2, it is a block diagram of details of the high frequency reconstructing step. The purpose of the high frequency reconstruction is to increase the frequency range of the filtered bone-conduction sensor signal. The DNN is used to reconstruct high frequencies. There are many implementations of the DNN and FIG. 2 shows, as one of them, a method of DNN based restructuring high frequency based on a long short-term memory (LSTM).

The Chinese Patent Application Number 201811199154.2, entitled “system for identifying voice of a user to control an electronic device through human vibration”, comprises a vibration sensor for sensing body vibration of a user, a processor circuit coupled to the vibration sensor for activating a voice pickup device to begin voice pickup when the output signal of vibration sensor detects voice of the user. In comparison with it, the invention uses bone-conducted signals as low frequency signals as input. Both the bone-conducted signals and the microphone signals are together sent to the DNN to fuse for reducing noise. Quality low frequency signals are obtained using the bone vibration sensor. Thereafter, noise is reduced.

Preferably, the DNN module comprises a signal processing unit for processing the filtered bone-conduction signal and the microphone signal and making predictions to obtain a clean speech.

Preferably, one of the implementations of the DNN module is a convolutional neural network (CNN) which can obtain a speech magnitude spectrum (SMS) by making predictions.

More preferably, the CNN is used in the DNN based combination model as an example, and the CNN can be replaced by LSTM or deep full CNN.

For example, the DNN module includes three CNNs, three LSTMs and three deconvolutional neural networks.

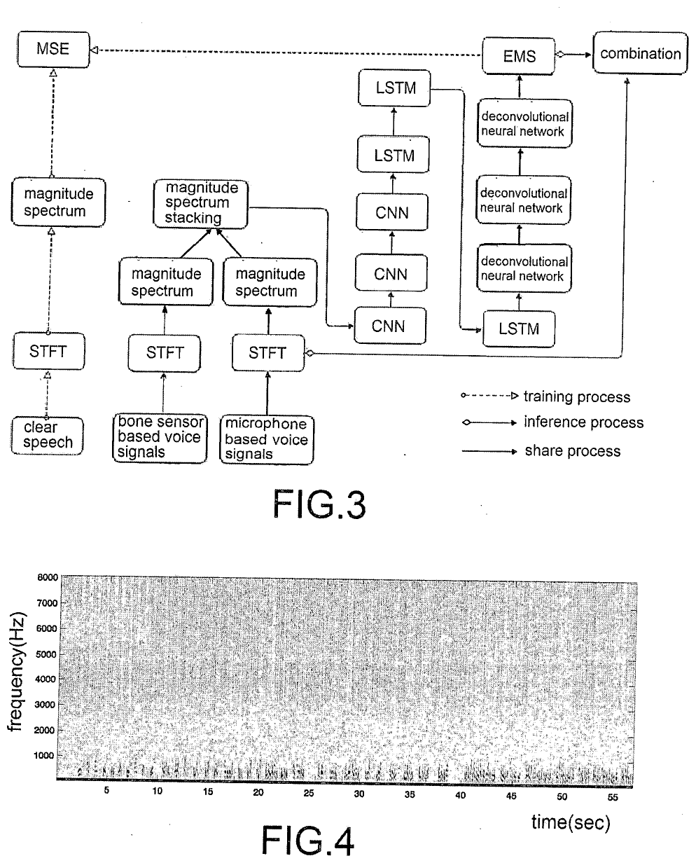

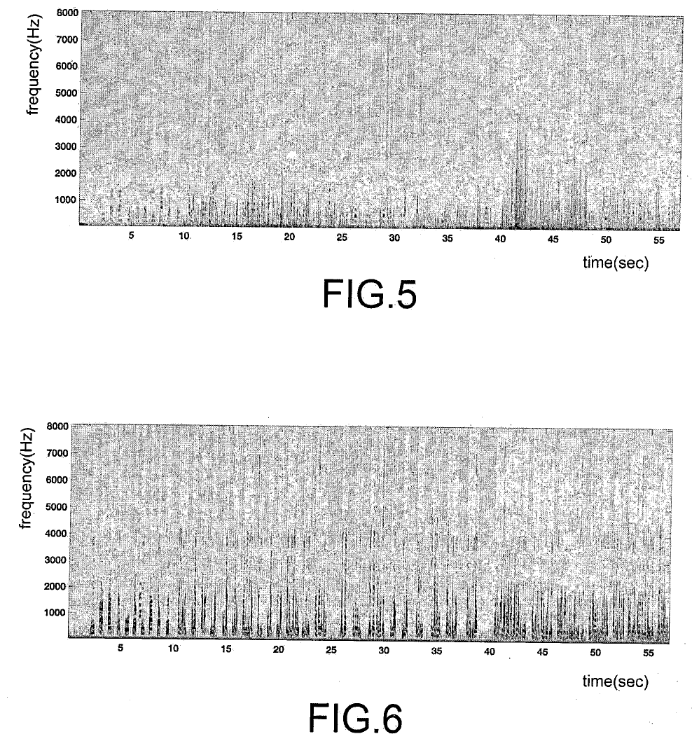

Referring to FIG. 3, it is a block diagram of DNN incorporated into the invention. The CNN is implemented, i.e., a training target of the DNN is SMS. First, the clear speech is subjected to Short-time Fourier transform (STFT) to obtain a SMS as a training target (e.g., a target magnitude spectrum (TMS)).

Preferably, input signals of the DNN module are generated by stacking both the SMS of the bone-conduction sensor signal and the SMS of the microphone signal.

First, both the bone-conduction sensor signal and the microphone signal are subjected to STFT to obtain two magnitude spectrums. The magnitude spectrums are configured to stack.

Preferably, the stacked magnitude spectrums are processed by the DNN module to generate an estimated magnitude spectrum (EMS) which is in turn outputted.

Preferably, each of the TMS and the EMS are subjected to mean squared error (MSE) which is used to measures the average of the squares of the errors, i.e., the average squared difference between the estimated values and the true values. More preferably, back propagation gradient descent is used to update network parameters in the training. In detail, training data is continuously sent to the network to update the network parameters until the network converges.

Preferably, inference is used to subject the microphone data to STFT to generate phases which are combined with the EMS to recover a clean speech.

In comparison to the conventional noise reduction methods, a single microphone is employed by the invention as input and thus the invention has advantages of being robust, having economical cost and simple specifications requirements. In the invention, the robustness means the performance of the noise reduction system is not influenced by the perturbation of microphone consistence and strong robustness means there are no requirements for microphone consistence and location of the microphone. In brief, the invention is applicable to various types of microphones.

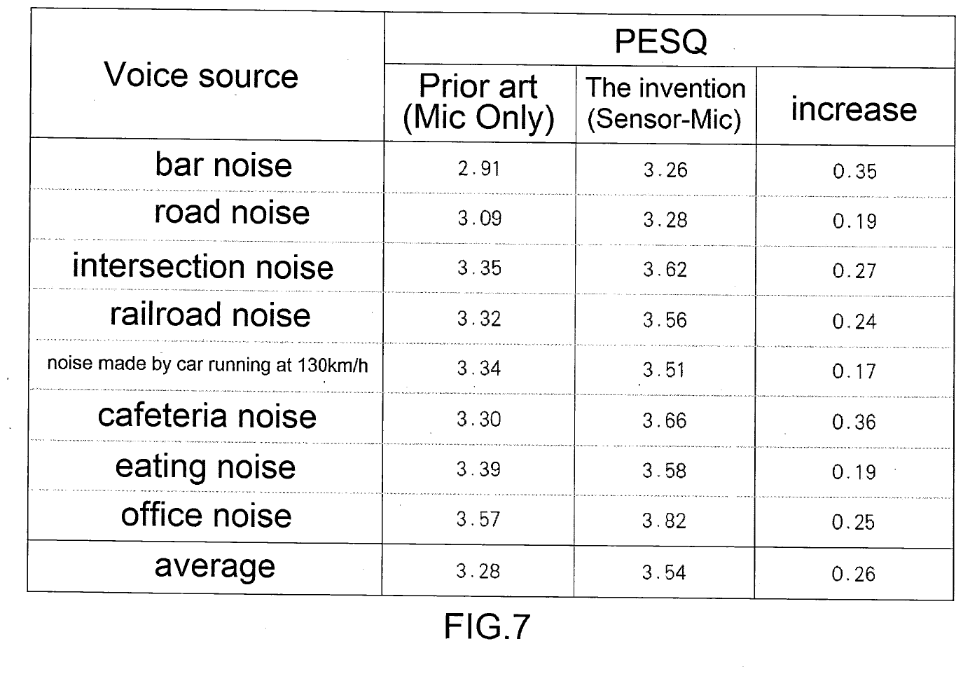

Referring to FIG. 7, it is a table of comparing the noise reduction method of the invention with the conventional noise reduction method without incorporating a bone-conduction sensor for monaural sound corresponding to deep learning in terms of eight different noisy environments and showing advantageous noise reduction results of the invention. Specifically, the table tabulates the comparison of the noise reduction method of the invention (i.e., sensor-microphone) with the conventional noise reduction method (i.e., Chinese Patent Application Number 201710594168.3) without incorporating a bone sensor for monaural sound corresponding to deep learning (i.e., microphone only) in terms of eight different noisy environments and showing advantageous noise reduction results of the invention. The eight different noise sources are bar noise, road noise, intersection noise, railroad noise, noise made by a car running at 130 km per hour, cafeteria noise, eating noise, and office noise. Both the invention and the conventional method are subjected to perceptual evaluation of speech quality (PESQ) having a range of [−0.5, 4.5]. As shown, the PESQ score of each noise source is greatly increased after being subjected to the method of the invention. Average of the increases scores is 0.26. In brief, the method of invention can reproduce high-quality sound and has a strong capability of cancelling noise.

The invention has the following advantageous effects in comparison with the prior art: The bone sensor is capable of collecting low frequency voice and is not interfered by air conducted acoustic noise. It is possible of effectively reducing noise in a very low SNR by transmitting both the bone-conduction sensor signal and the microphone signal to the DNN module, and activating the DNN module to analyze and process the combined signals. In comparison with the conventional method of using a single microphone for noise reduction, the invention can reproduce high-quality sound, has a strong capability of cancelling noise, and effectively extracts target speech from noisy background by employing the strong modeling capability of the DNN. The method of the invention is applicable to conversation earphone or a cellular phone contacted an ear (or any of other body parts). In contrast to the conventional noise reduction method of employing only bone sensor signals while having installed bone sensor and microphone, the method of the invention takes the bone sensor signals as input by taking advantage of the bone sensor signals not being affected by acoustic noise interference. Further, the method of the invention transmits both the bone-conduction sensor signal and the microphone signal to the DNN module, and activates the DNN module to process both signals and make predictions, thereby obtaining a clean speech as implemented in the first embodiment; or transmits both the filtered bone sensor signals having an increased frequency and the microphone signals from the microphone to the DNN module, and activates the DNN module to process both signals and make predictions, thereby obtaining a clean speech in the embodiment. The method of the invention can generate low frequency signals of high quality by taking advantage of the bone sensor. Further, the method of the invention can greatly increase prediction accuracy of the DNN, thereby obtaining a clean speech. Alternatively, the filtered bone sensor signals having an increased frequency can be outputted.

In the embodiment, the filtered bone-conducted signal is further subjected to a high frequency reconstruction module to extend the frequency of the filtered bone-conducted signals so that a bandwidth of the filtered bone-conducted signals is increased and the filtered bone-conducted signals are further sent to the DNN module. Preferably, one of the implementations of the DNN module is CNN which can obtain SMS by making predictions. More preferably, the CNN is used in the DNN based combination model as an example, and the CNN can be replaced by LSTM or deep full CNN.

The invention provides a deep learning based noise reduction method of processing signals from both a bone sensor and a microphone by taking advantage of the bone sensor signals and the microphone signals. Further, the invention can reproduce high-quality sound, has a strong capability of suppressing noise, and effectively collect speech from noisy background by employing the strong modeling capability of the DNN. Thus, a clean speech with noise being substantially suppressed is reproduced. Finally, both complexity and cost are greatly decreased by taking advantage of a single microphone.

While the invention has been described in terms of preferred embodiments, those skilled in the art will recognize that the invention can be practiced with modifications within the spirit and scope of the appended claims.

1. A deep learning speech extraction and noise reduction method fusing signals of bone vibration sensor and microphone, comprising the steps of:
S1 a bone vibration sensor and a microphone collecting audio signals to respectively obtain a bone vibration sensor audio signal and a microphone audio signal;
S2 inputting the bone vibration sensor audio signal into a high-pass filter module, and performing high-pass filtering;
S3 inputting the bone vibration sensor audio signal subjected to high-pass filtering or a signal subjected to frequency band broadening and the microphone audio signal into a deep neural network module; and
S4 the deep neural network model obtaining, by means of prediction, speech have been subjected fusing and noise reduction.

2. The deep learning speech extraction and noise reduction method fusing signals of bone vibration sensor and microphone of claim 1, wherein the high-pass filter modifies a direct current offset of the bone sensor signal and filters out low frequency noise signals.

3. The deep learning speech extraction and noise reduction method fusing signals of bone vibration sensor and microphone of claim 2, wherein the filtered bone-conducted signal is further subjected to a high frequency reconstruction module to extend the frequency of the filtered bone-conducted signals to more than 2 kHz so that a bandwidth of the filtered bone-conducted signals is increased and the filtered bone-conducted signals are further sent to the DNN module.

4. The deep learning speech extraction and noise reduction method fusing signals of bone vibration sensor and microphone of claim 3, wherein after subjecting the bone-conducted signals to the high frequency restructuring, the bone-conducted signals can be outputted.

5. The deep learning speech extraction and noise reduction method fusing signals of bone vibration sensor and microphone of claim 1, wherein the DNN module comprises a fusing module for fusing the speech signals from the microphone and the bone-conducted signals from the bone-conduction sensor into noise reduction.

6. The deep learning speech extraction and noise reduction method fusing signals of bone vibration sensor and microphone of claim 5, wherein one of a plurality of implementations of the DNN module is a convolutional neural network (CNN) which is capable of obtaining a speech magnitude spectrum (SMS) by making predictions.

7. The deep learning speech extraction and noise reduction method fusing signals of bone vibration sensor and microphone of claim 1, wherein the DNN module comprises a plurality of the CNNs, a plurality of long short-term memories (LSTMs), and a plurality of deconvolutional neural networks.

8. The deep learning speech extraction and noise reduction method fusing signals of bone vibration sensor and microphone of claim 6, wherein the clean speech is subjected to Short-time Fourier transform (STFT) to obtain a SMS as a target magnitude spectrum (TMS).

9. The deep learning speech extraction and noise reduction method fusing signals of bone vibration sensor and microphone of claim 6, wherein input signals of the DNN module are generated by stacking the SMS of the bone sensor based signal and the SMS of the microphone based voice signal; wherein both the bone sensor based signal and the microphone based voice signal are subjected to STFT to obtain two magnitude spectrums; and wherein the magnitude spectrums are configured to stack.

10. The deep learning speech extraction and noise reduction method fusing signals of bone vibration sensor and microphone of claim 9, wherein the stacked magnitude spectrums are processed by the DNN module to generate an estimated magnitude spectrum (EMS) to be outputted.

11. The deep learning speech extraction and noise reduction method fusing signals of bone vibration sensor and microphone of claim 8 or 10, wherein each of the TMS and the EMS are subjected to mean squared error (MSE).
